(19) United States
(12) Patent Application Publication
(10) Pub. No.: US 2025/0212267 A1
(43) Pub. Date: Jun. 26, 2025

(54) SYSTEMS AND METHODS FOR CONNECTION MANAGEMENT

(71) Applicant: Comcast Cable Communications, LLC, Philadelphia, PA (US)

(72) Inventors: Yeqing WANG, Horsham, PA (US); Ganesh Babu Venkata Ramana RAMALINGAM, Berwyn, PA (US)

(21) Appl. No.: 18/393,262

(22) Filed: Dec. 21, 2023

(51) Int. Cl. H04W 76/11; H04W 76/12; H04W 80/04; H04W 88/16

(52) U.S. Cl. CPC H04W 76/11; H04W 76/12; H04W 80/04; H04W 88/16

(57) ABSTRACT

Methods and systems for connection management are disclosed. A gateway device may provide services, such as a static IP service, to a user device via a first network. If the first network fails, a network assistance device may connect to a second network to maintain the services. If the user device connects to the network assistance device, the user device may be able to maintain the static IP address.

### BACKGROUND

A network assistance device (e.g., Wi-Fi extender device) may be used to extend (e.g., expand) the range of a gateway device located at a premises. The network assistance device may be connected (e.g., wirelessly) to the gateway device. A user device that is out of range of the gateway device may establish a connection with the network assistance device. Based on establishing the connection with the network assistance device, the user device may send and receive data via the gateway device. However, the network assistance device may be unable to extend the range of the gateway device if the gateway device is unable to establish a wide area network (WAN) connection and/or if the network assistance device is not located at the premises. Therefore, improved connection management techniques are desirable.

### SUMMARY

Methods, systems, and devices for connection management are disclosed. A network assistance device may offer various services. The network assistance device may provide the services via a first network. A user associated with the network assistance device may need the services provided by the network assistance device to work all of the time, regardless of whether the first network fails, or the user takes the extender outside of a range of a gateway device (e.g., access point) of the first network. If the first network fails, or if the user takes the extender outside of a range of the gateway device, the network assistance device may connect to a second network to maintain the services. One of the services provided by the network assistance device may be the maintenance of a static IP address associated with the gateway device. If the first network fails, the network assistance device may establish a tunnel (e.g., via a cell phone provider network) between the network assistance device and a component in the first network. The tunnel may be used to route data that is addressed to the static IP address to the network assistance device, effectively causing the network assistance device to function as if it were the gateway device by providing network access at the premises. If the user takes the extender outside of a range of the gateway device, the network assistance device may establish a tunnel (e.g., via a cell phone provider network) between the network assistance device and the gateway device. The tunnel may be used to route data that is addressed to the static IP address from the gateway device to the network assistance device, effectively causing the network assistance device to appear to be located at the same premises as the gateway device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 is an example system.

FIG. 2 is an example system.

FIG. 3 is an example system.

FIG. 4 is an example system.

FIG. 5 is an example system.

FIG. 6 is an example method.

FIG. 7 is an example method.

FIG. 8 is an example method.

FIG. 9 is an example method.

FIG. 10 is an example method.

FIG. 11 is an example method.

FIG. 12 is an example computing device.

### DETAILED DESCRIPTION OF ILLUSTRATIVE EMBODIMENTS

Methods and systems for connection management are disclosed. A network assistance device (e.g., Wi-Fi extender device) may be used to extend (e.g., expand) the range of a gateway device (e.g., or computing device, network device, access point) located at a premises and connected (e.g., wirelessly) to a first network (e.g., service provider network, content provider network). The network assistance device may be connected (e.g., wirelessly) to the gateway device. A user device may be out of range of the gateway device. For example, the user device may be located in a certain area of the premises where the user device is unable to receive a signal from the gateway device. The user device may connect to the network assistance device to access the first network (e.g., via the connection of the network assistance device to the gateway device). The network assistance device may communicate signals between the user device and the gateway device, thus connecting the user device to the first network.

In some scenarios, the network assistance device may be unable to connect the user device to the first network, such as if the connection between the gateway and the first network fails or if the network assistance device is no longer within range or otherwise able to connect to the gateway device. Accordingly, improved techniques for connection management are desirable.

Described herein are improved techniques for connection management. The techniques described herein enable a user device to connect to the first network via a network assistance device even if the gateway device is unable to establish a connection with the first network and/or if the network assistance device is no longer within range or otherwise able to connect to the gateway device.

The network assistance device described herein may enable a user to access the services provided by the network assistance device all of the time, regardless of whether the first network fails, or the user takes the extender outside of a range of a gateway device of the first network. One of the services provided by the network assistance device may be the maintenance of a static IP address associated with the gateway device. If the first network fails, the network assistance device may establish a tunnel (e.g., via a cellular provider network) between the network assistance device and a component in the first network. If a user takes the extender outside of a range of a gateway device of the first network, the network assistance device may establish a tunnel (e.g., via a cellular provider network) between the network assistance device and the gateway device. The tunnel may be used to maintain the static IP address associated with the gateway device. For example, if a user (e.g., customer, subscriber) of the first network has a server associated with a static IP address, customer(s) of the user may request a website from the static IP address and the request may be routed via the tunnel (e.g., from the first network to the cellular provider network).

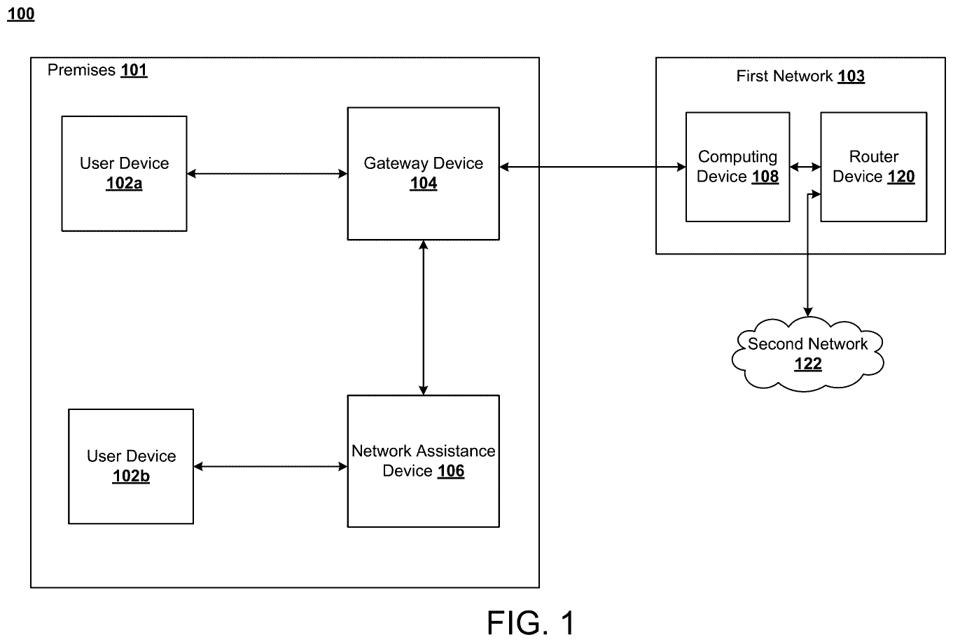

FIG. 1 shows a block diagram of an example system 100. The system 100 may comprise user devices 102a-b, a gateway device 104 (e.g., or computing device, network device, access point), a network assistance device 106 (e.g., or computing device, network device, access point), a first network, 103, a second network 122, or any combination thereof. It should be noted that while the singular term device is used herein, it is contemplated that some devices may be implemented as a single device or a plurality of devices (e.g., via load balancing). The user devices 102a-b, the gateway device 104, and the network assistance device 106 may each be implemented as one or more computing devices. Any device disclosed herein may be implemented using one or more computing nodes, such as virtual machines, executed on a single device and/or multiple devices.

The gateway device 104 may comprise a router. The gateway device 104 may comprise a modem. The gateway device 104 may be configured to provide a connection to the second network 122 and/or the Internet via the first network 103. The first network 103 may comprise a service provider, content provider (e.g., distributor) and/or access network. The first network 103 may facilitate communication via one or more communication protocols. The first network 103 may comprise any of a variety of types of networks, such as, for example, a coaxial cable network, a fiber-optic cable network, a hybrid fiber-coaxial (HFC) network, a satellite transmission channel, a DSL connection, or the like. The first network 103 may comprise fiber, cable, a combination thereof. The first network 103 may comprise wired links, wireless links, a combination thereof, and/or the like. The first network 103 may comprise routers, switches, nodes, gateways, servers, modems, and/or the like. The second network 122 may comprise one or more networks, such as a wide area network (e.g., the Internet), a cellular network, a Long Term Evolution (LTE) network, one or more service provider networks, and/or the like.

The first network 103 may comprise a network device (e.g., termination system, terminal, fiber mode, network end point, etc.), such as a computing device 108. The computing device 108 may comprise a cable modem termination system (CMTS), a digital subscriber line access multiplexer (DSLAM), or an optical line terminal (OLT). The computing device 108 may be located at a headend of the content provider 103. The computing device 108 may be configured to provide high speed data services, such as cable Internet or Voice over Internet Protocol or IP Video, to user devices, such as the user devices 102a-b. The computing device 108 may be configured to provide the high speed data services to user devices based on a connection established between the computing device 108 and the second network 122. The computing device 108 may be connected to the second network 122, such as via a router device 120.

The gateway device 104 may be connected to the first network 103. The gateway device 104 may be connected to the first network 103 via the computing device 108. The gateway device 104 and the computing device 108 may be connected, such as via a HFC connection. The gateway device 104 may be configured to send data to the computing device 108, such as using Data Over Cable Service Interface Specification (DOCSIS). The computing device 108 may be configured to receive data from the gateway device 104. The computing device 108 may be configured to send data to the gateway device 104, such as using DOCSIS. The gateway device 104 may be configured to receive data from the computing device 108.

The user devices 102a-b, the gateway device 104, and the network assistance device 106 may be located at a premises 101. The premises 101 may comprise a property, dwelling, terminal, building, floor, and/or the like. The premises 101 may comprise different rooms, walls, door, windows, and/or the like. The user device 102a and/or the user device 102b may move within and/or outside the premises 101. The user device 102a and/or the user device 102b may be fixed at a stationary location within the premises 101. The user devices 102a-b may each comprise a computing device, a smart device (e.g., smart glasses, smart watch, smart phone), a mobile device, a tablet, a computing station, a laptop, a digital streaming device, a streaming stick, a television, and/or the like.

The premises 101 may include a first area within a coverage range (e.g., wireless range) of the gateway device 104. The user device 102a may be located in the first area of the premises 101. The user device 102a and the gateway device 104 may be connected, such as via a local area network (LAN) or wireless local area network (WLAN). The user device 102a may be configured to send data to the gateway device 104. The gateway device 104 may be configured to receive data from the user device 102a. The gateway device 104 may be configured to send data to the user device 102a. The user device 102a may be configured to receive data from the gateway device 104.

Thus, the user device 102a may be connected to the first network 103 via the gateway device 104. The user device 102a may send uplink data to the computing device 108 via the gateway device 104. To send uplink data to the computing device 108, the user device 102a may send uplink data to the gateway device 104. The gateway device 104 may receive the uplink data and forward (e.g., send) the uplink data to the computing device 108. The user device 102a may receive downlink data from the computing device 108 via the gateway device 104. The computing device 108 may send downlink data to the gateway device 104. The gateway device 104 may receive the downlink data and forward (e.g., send) the downlink data to the user device 102a.

The premises 101 may include a second area outside of the coverage range (e.g., wireless range) of the gateway device 104. If the user device 102b is located in the second area of the premises 101, the user device 102b may be unable to connect to the gateway device 104. The second area may be within a coverage range of the network assistance device 106. If the user device 102b is located in the second area of the premises 101, the user device 102b may be connected to the network assistance device 106, such as via a LAN or wireless LAN. The user device 102b may be configured to send data to the network assistance device 106. The network assistance device 106 may be configured to receive data from the user device 102b. The network assistance device 106 may be configured to send data to the user device 102b. The user device 102b may be configured to receive data from the network assistance device 106.

The network assistance device 106 and the gateway device 104 may be connected, such as via a Wi-Fi mesh network. The gateway device 104 may be configured to send data to the network assistance device 106. The network assistance device 106 may be configured to receive data from the gateway device 104. Based on (e.g., in response to) receiving data from the gateway device 104, the network assistance device 106 may send (e.g., forward) at least a portion of the received data to the user device 102b. The network assistance device 106 may be configured to send data to the gateway device 104. The network assistance device 106 may receive data from the user device 102b and send (e.g., forward) the received data to the gateway device 104. The gateway device 104 may be configured to receive data from the network assistance device 106.

Thus, the user device 102b may be connected to the first network 103 via the network assistance device 106. The user device 102b may receive downlink data from the computing device 108 via the network assistance device 106. The computing device 108 may send downlink data to the gateway device 104. The gateway device 104 may forward (e.g., send) the downlink data to the network assistance device 106. The network assistance device 106 may forward (e.g., send) the downlink data to the user device 102b. The user device 102b may send uplink data to the computing device 108 via the network assistance device 106. The user device 102b may send uplink data to the network assistance device 106. The network assistance device 106 may receive the uplink data and forward (e.g., send) the uplink data to the gateway device 104. The gateway device 104 may receive the uplink data and forward (e.g., send) the uplink data to the computing device 108. As such, the user device 102b may be connected to the first network 103 (e.g., through the network assistance device 106), despite the user device 102b being located outside of the coverage range (e.g., wireless range) of the gateway device 104.

The network assistance device 106 may be unable to connect the user device 102b to the first network 103 based on network condition associated with the first network 103. The network condition 103 may comprise a state of a connection between the gateway device 104 and the first network 103. For example, the network assistance device 106 may be unable to connect the user device 102b to the first network 103 if the gateway device 104 is unable to establish a connection (e.g., WAN connection, DOCSIS WAN connection) with the first network 103. As another example, the network assistance device 106 may be unable to connect the user device 102b to the first network 103 if the connection between the gateway device 104 and the first network 103 is weak and/or interrupted. As another example, the network assistance device 106 may be unable to connect the user device 102b to the first network 103 based on a power outage associated with the gateway device 104.

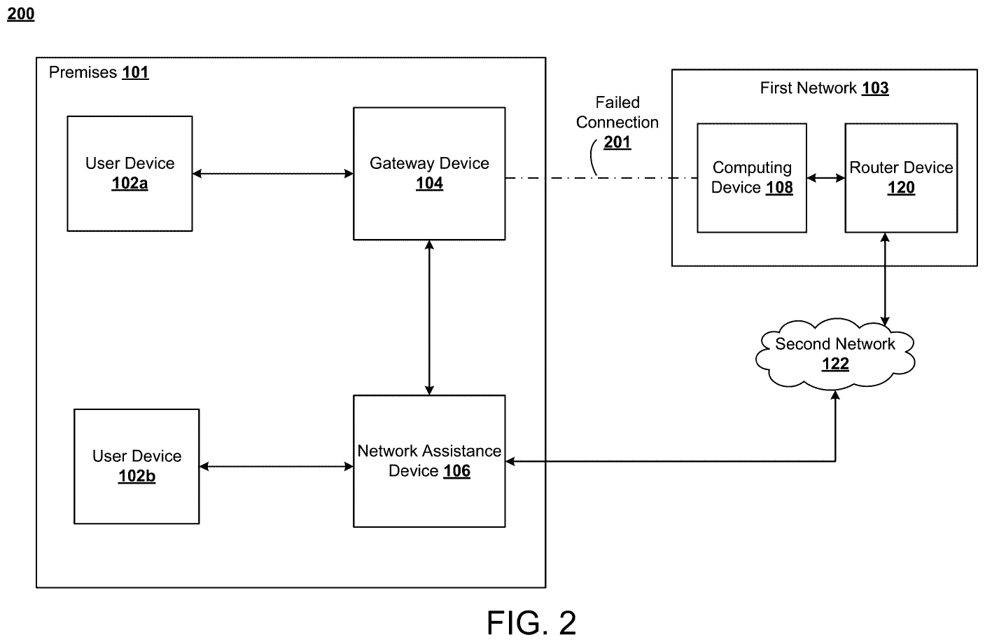

FIG. 2 shows an example system 200. The system 200 may comprise the user devices 102a-b, the gateway device 104, the network assistance device 106, the first network 103, and the second network 122. The network assistance device 106 may be located at the premises 101. The gateway device 104 may not be connected to the first network 103. The gateway device 104 may not be connected to the first network 103 based on network condition associated with the first network 103. The network condition associated with the first network 103 may comprise a state of a connection between the gateway device 104 and the first network 103 (e.g., the computing device 108).

A failed connection 201 may exist between the gateway device 104 and the computing device 108. The failed connection 201 may exist between the gateway device 104 and the computing device 108 if the gateway device 104 is unable to establish a connection (e.g., WAN connection, DOCSIS WAN connection) with the computing device 108. The gateway device 104 may be unable to establish a connection (e.g., WAN connection, DOCSIS WAN connection) with the computing device 108 based on a DOCSIS link failure. The failed connection 201 may exist between the gateway device 104 and the computing device 108 if a previously established connection between the gateway device 104 and the computing device 108 is interrupted or broken. The failed connection 201 may exist between the gateway device 104 and the computing device 108 if a previously established connection between the gateway device 104 and the computing device 108 is weak. The failed connection 201 may exist between the gateway device 104 and the computing device 108 if the gateway device 104 experiences a loss of power or any planned or unplanned maintenance activity at the gateway device 104 and/or the computing device 108.

The network assistance device 106 may be configured to determine the network condition associated with the first network 103. To determine the network condition associated with the first network 103, the network assistance device 106 may determine a state of the connection between the gateway device 104 and the first network 103. To determine a state of the connection between the gateway device 104 and the first network 103, the network assistance device 106 may send a message (e.g., signal, heartbeat) to the gateway device 104. Based on (e.g., in response to) sending the message to the gateway device 104, the network assistance device 106 may wait to receive a response message (e.g., response signal, heartbeat) from the gateway device 104. If the network assistance device 106 receives a response message from the gateway device 104, such as within a predetermined amount of time, the network assistance device 106 may determine that the failed connection 201 does not exist between the gateway device 104 and the computing device 108. The predetermined amount of time may be any number of minutes, seconds, or milliseconds, such as 500 milliseconds, one second, two seconds, etc. Conversely, if the network assistance device 106 does not receive a response message from the gateway device 104, such as within a predetermined amount of time, the network assistance device 106 may determine that the failed connection 201 does exist between the gateway device 104 and the computing device 108.

The network assistance device 106 may be configured to establish a connection with the second network 122. The network assistance device 106 may be configured to establish a connection with the second network 122 based on (e.g., in response to) the network condition associated with the first network 103. The network assistance device 106 may be configured to establish a connection with the second network 122 based on (e.g., in response to) a state of the connection between the gateway device 104 and the first network 103. For example, the network assistance device 106 may be configured to establish a connection with the second network 122 based on determining that the failed connection 201 exists between the gateway device 104 and the computing device 108. As described above, the second network 122 may comprise one or more networks, such as a wide area network (e.g., the Internet), a cellular network, an LTE network, one or more service provider networks, and/or the like. The network assistance device 106 may connect to the second network 122 via a wireless access point (e.g., a cellular tower, etc.). The wireless access point may be connected to a WAN, such as a WAN comprising the first network 103.

The network assistance device 106 may be configured to connect the user device 102a to the first network 103 and/or the Internet via the second network 122. The user device 102a may send uplink data to one or more of the Internet, the router device 120, or any back-end systems within the first network 103 via the network assistance device 106. To send the uplink data, the user device 102a may send uplink data to the gateway device 104. The gateway device 104 may forward (e.g., send) the received uplink data to the network assistance device 106. The network assistance device 106 may forward (e.g., send) such uplink data to the router device 120. The network assistance device 106 may forward the uplink data to the Internet and/or router device 120 via the second network 122. The second network 122 may send (e.g., forward) the uplink data from the network assistance device 106 to the router device 120 in the first network 103. The router device 120 may send (e.g., forward) the received uplink data to any systems within the first network 103. The user device 102a may receive downlink data from the Internet, the systems within the first network 103, and/or the router device 120 via the network assistance device 106. The downlink data from the systems within the first network 103 may be received at the router device 120. The router device 120 may receive the downlink data and forward (e.g., send) the downlink data to the network assistance device 106, such as via the second network 122. The downlink data from the Internet may be received at the network assistance device 106, such as via the second network 122. The network assistance device 106 may receive the downlink data and forward (e.g., send) the downlink data to the gateway device 104. The gateway device 104 may receive the downlink data and forward (e.g., send) the downlink data to the user device 102a. As such, the user device 102a may be connected to the first network 103 and/or the Internet (e.g., through the network assistance device 106), despite the failed connection 201 between the gateway device 104 and the computing device 108.

The network assistance device 106 may be configured to connect the user device 102b to the first network 103 and/or the Internet via the second network 122. The user device 102b may send uplink data to the Internet, the router device 120, and/or any systems within the first network 103 via the network assistance device 106. The user device 102b may send uplink data to the network assistance device 106. The network assistance device 106 may receive the uplink data and forward (e.g., send) the uplink data to the router device 120, the Internet, and/or any systems within the first network 103 via the second network 122. The second network 122 may receive the uplink data and forward the uplink data to the Internet and/or one or more systems with the first network 103. The router device 120 may send (e.g., forward) the received uplink data to one or more systems within the first network 103. The user device 102b may receive downlink data from the Internet via second network 122 and/or the network assistance device 106. The systems within the first network 103 may send downlink data to the router device 120. The router device 120 may receive the downlink data and forward (e.g., send) the downlink data to the network assistance device 106, such as via the second network 122. The network assistance device 106 may receive the downlink data and forward (e.g., send) the downlink data to the user device 102b. As such, the user device 102b may be connected to the first network 103 (e.g., through the network assistance device 106), despite the failed connection 201 between the gateway device 104 and the computing device 108.

Referring back to FIG. 1, the network assistance device 106 may be unable to connect the user device 102b to the first network 103 if the network assistance device 106 is not located at the premises 101. If the network assistance device 106 is not located at the premises 101, the network assistance device 106 may be unable to establish the necessary connection with the gateway device 104.

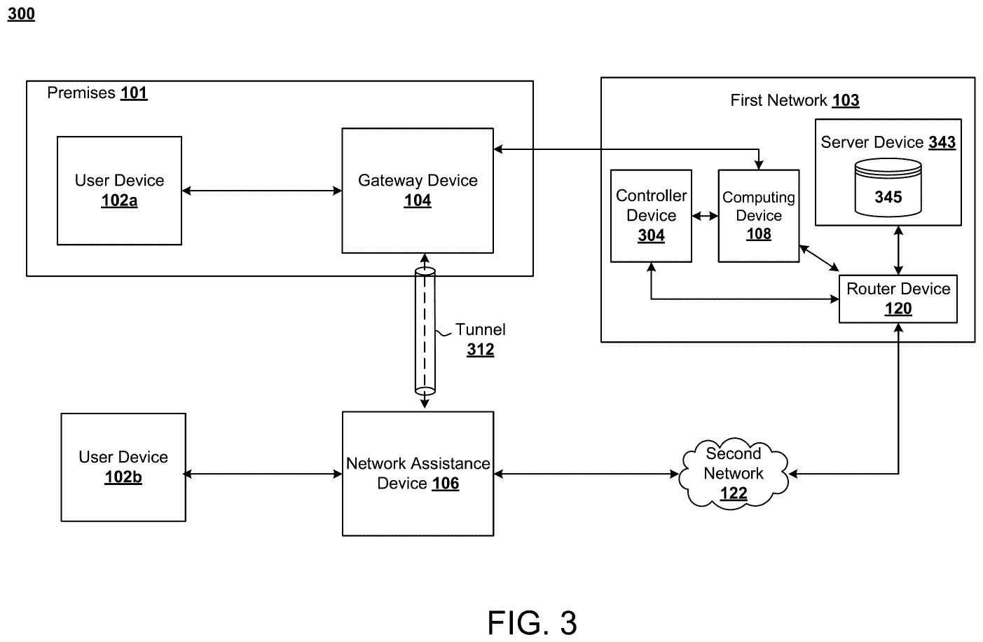

FIG. 3 is an example system 300. The system 300 may comprise the user devices 102a-b, the gateway device 104, the network assistance device 106, the first network 103, and the second network 122. The user device 102a and the gateway device 104 may be located at the premises 101. However, the user device 102b and the network assistance device 106 may not be located at the premises 101. The user device 102b and the network assistance device 106 may be located at a second, different premises. The different premises may comprise a property, dwelling, terminal, building, floor, and/or the like. The different premises may be outdoors. The different premises may be in a public location (e.g., park, restaurant, cafe, etc.). The user device 102b and the network assistance device 106 may be in transit (e.g., traveling to or from the first premises 101).

The user device 102a may be connected to the first network 103 in the same manner as described above with regard to FIG. 1. The user device 102a may be connected to the first network 103 via the gateway device 104. The user device 102a may send uplink data to the computing device 108 via the gateway device 104. To send uplink data to the computing device 108, the user device 102a may send uplink data to the gateway device 104. The gateway device 104 may receive the uplink data and forward (e.g., send) the uplink data to the computing device 108. The user device 102a may receive downlink data from the computing device 108 via the gateway device 104. The computing device 108 may send downlink data to the gateway device 104. The gateway device 104 may receive the downlink data and forward (e.g., send) the downlink data to the user device 102a.

The network assistance device 106 may be configured to determine whether the network assistance device 106 is located at the premises 101. To determine whether the network assistance device 106 is located at the premises 101, the network assistance device 106 may send a message (e.g., signal, heartbeat) to the gateway device 104. Based on (e.g., in response to) sending the message to the gateway device 104, the network assistance device 106 may wait to receive a response message (e.g., response signal, heartbeat) from the gateway device 104. If the network assistance device 106 receives a response message from the gateway device 104, such as within a predetermined amount of time, the network assistance device 106 may determine that the network assistance device 106 is located at the premises 101. The predetermined amount of time may be any number of minutes, seconds, or milliseconds, such as 500 milliseconds, one second, two seconds, etc. If the network assistance device 106 does not receive a response message from the gateway device 104, such as within a predetermined amount of time, the network assistance device 106 may determine that the network assistance device 106 is not located at the premises 101.

To determine whether the network assistance device 106 is located at the premises 101, the network assistance device may use geolocation. The network assistance device 106 may determine geolocation data (e.g., latitude and longitude coordinates) associated with the network assistance device 106. The network assistance device 106 may determine the geolocation data using any suitable geolocation technique. The network assistance device 106 may compare the geolocation data associated with the network assistance device 106 to known geolocation data associated with the gateway device 104 and/or the premises 101 to determine whether the network assistance device 106 is located at the premises 101 or not.

The network assistance device 106 may use geolocation data in addition to, or as an alternative to, the heartbeat message to determine whether the network assistance device 106 is located at the premises 101. Using geolocation data to determine or verify whether the network assistance device 106 is located at the premises 101 may prevent the network assistance device 106 from falsely determining that the network assistance device 106 is not located at the premises 101 based on a weak or intermittent connection between the network assistance device 106 and the gateway device 104.

The network assistance device 106 may be configured to establish a connection with the second network 122. The network assistance device 106 may be configured to establish a connection with the second network 122 based on (e.g., in response to) determining that the network assistance device 106 is not located at the premises 101. As described above, the second network 122 may comprise one or more networks, such as a wide area network (e.g., the Internet), a cellular network, an LTE network, one or more service provider networks, and/or the like. The network assistance device 106 may connect to the second network 122 via a wireless access point (e.g., a cellular tower). The wireless access point may be connected to a WAN, such as a WAN comprising the first network 103.

The first network 103 may comprise a server device 343. The server device 343 may be configured to store data 345. The data 345 may comprise connection data. The connection data may indicate one or more candidate networks and/or candidate hot spots that may be used to connect to the first network 103. The candidate networks may comprise one or more cellular networks and/or one or more Wi-Fi networks, such as private open Wi-Fi networks (e.g., an open Wi-Fi network at an airport, café, library, etc.). The candidate hot spots may comprise one or more c hot spots (e.g., public Wi-Fi hot spots). The connection data may indicate, for each candidate network and/or hot spot, performance data, trustworthiness data, risk level data, parameters, credentials, etc. The connection data may be generated by the first network 103. The first network 103 may generate the connection data based on data indicating networks and/or candidate hot spots that users (e.g., subscribers, customers) of the first network 103 have previously used to connect to the first network 103. The connection data may be generated using one or more machine learning algorithms.

Based on establishing the connection with the second network 122, the network assistance device 106 may send location data to the server device 343. The location data may indicate a location of the network assistance device 106. The network assistance device 106 may send the location data to the server device 343 based on the connection with the second network 122. The server device 343 may receive the location data.

Based on (e.g., using) the location data, the server device 343 may determine a preferred (e.g., best) network and/or hot spot for connecting to the first network 103. For example, the server device 343 may determine, based on the connection data and the location of the network assistance device 106, a list of one or more candidate networks and/or candidates hot spots that are available for the network assistance device 106 to connect to. The server device 343 may determine the preferred network or hot spot from the list of available networks and/or hot spots.

Determining the preferred network or hot spot may comprise determining the available network or hot spot associated with the lowest cost, strongest connection to the content network 103, and/or lowest security risk. Hot spots associated with the first network 103 may be preferred over cellular networks, as connecting to the first network 103 via a hot spot associated with the first network 103 may be much cheaper (e.g., for the content network 103) than connecting to the first network 103 via a cellular network. Wi-Fi networks may be preferred over cellular networks, as connecting to the first network 103 via a Wi-Fi network associated with the first network 103 may be much cheaper (e.g., for the content network 103) than connecting to the first network 103 via a cellular network. Wi-Fi networks with stronger connections and/or lower security risks may be preferred over Wi-Fi networks with weak connections and/or higher security risks.

The server device 343 may send a message to the network assistance device 106. The message may comprise an instruction for the network assistance device 106 to connect to the preferred network or hot spot. If the preferred network or hot spot is different from the second network 122 that the network assistance device 106 initially connected to, the network assistance device 106 may connect to the preferred network or hot spot based on (e.g., in response to) receiving the message. The network assistance device 106 may be connected to the first network 103 via the preferred network or hot spot. If the preferred network is the same as the second network 122 that the network assistance device 106 initially connected to, the network assistance device 106 may maintain its connection with the second network 122 based on (e.g., in response to) receiving the message.

A user associated with the network assistance device 106 may manually override the instruction if the user does not want the network assistance device 106 to connect to the preferred network. If the user manually overrides the instruction, the user may select a different network by which to connect to the first network 103. The user-selected network may be sent back to the server device 343. The server device 343 may update the connection data based on the user-selected network.

As described above, the server device 343 may be configured to store data 345. The data 345 may comprise connection data indicating one or more candidate networks that may be used to connect to the first network 103. The data 345 may comprise security setting data. The server device 343 may be configured to provide a security service based on (e.g., using) the security setting data. The security setting data may indicate security settings for each candidate network. The security settings for a particular candidate network may indicate that one or more ports should be blocked if the network assistance device 106 is connected to that network. The security settings for a particular candidate network may indicate that a firewall security should be increased if the network assistance device 106 is connected to that network. The security settings for a particular candidate network may indicate that certain protocols should be filtered out if the network assistance device 106 is connected to that network. For example, the security settings for a particular candidate network may indicate that only Hypertext Transfer Protocol (HTTP) should be used if the network assistance device 106 is connected to that network. The security settings for a particular candidate network may indicate that content associated with one or more specified content ratings should be blocked if the network assistance device 106 is connected to that network. For example, the security settings for a Wi-Fi network associated with a school or a public library may indicate that content rated unsuitable for children should be blocked if the network assistance device 106 is connected to that network.

The security setting data may indicate security settings for various locations. The security settings for a particular location may indicate that one or more ports should be blocked if the network assistance device 106 is at the location. The security settings for a particular location may indicate that a firewall security should be increased if the network assistance device 106 is at the location. The security settings for a particular location may indicate that certain protocols should be filtered out if the network assistance device 106 is at the location. For example, the security settings for a particular location may indicate that only Hypertext Transfer Protocol (HTTP) should be used if the network assistance device 106 is at the location. The security settings for a particular location may indicate that content associated with one or more specified content ratings should be blocked if the network assistance device 106 at the location. For example, the security settings for a location such as a school or a public library may indicate that content rated unsuitable for children should be blocked if the network assistance device 106 is at the location.

To provide the security service based on (e.g., using) the security setting data, the server device 343 may send (e.g., push down) security setting data to the network assistance device 106. The server device 343 may send (e.g., push down) the security setting data corresponding to the network to which the network assistance device 106 is connected. As described above, the network to which the network assistance device 106 is connected may be the second network 122 (or the preferred network or hot spot if it is different than the second network 122). The server device 343 may send (e.g., push down) the security setting data corresponding to the location at which the network assistance device 106 is located. The network assistance device 106 may receive the security setting data. Based on (e.g., in response to) receiving the security setting data, the network assistance device 106 may configure one or more settings of the network assistance device 106. The network assistance device 106 may configure the one or more settings of the network assistance device 106 based on (e.g., using) the security settings indicated by the received security setting data.

The network assistance device 106 may be configured to connect the user device 102b to the first network 103 via the second network 122 (or the preferred network or hot spot if it is different than the second network 122). The user device 102b may send uplink data to the Internet and/or the systems within the first network 103 via the network assistance device 106. The user device 102b may send uplink data to the network assistance device 106. The network assistance device 106 may receive the uplink data and forward (e.g., send) the uplink data to the Internet and/or systems within the first network 103 via the router device 120 through the second network 122 (or the preferred network or hot spot if it is different than the second network 122). The router device 120 may send (e.g., forward) the received uplink data to the server device 343 and/or any systems within the first network 103. The user device 102b may receive downlink data from the server device 343 and/or any systems within the first network 103 via the network assistance device 106. The server device 343 may send downlink data to the router device 120. The router device 120 may receive the downlink data and forward (e.g., send) the downlink data to the network assistance device 106, such as via the second network 122 (or the preferred network or hot spot if it is different than the second network 122). The network assistance device 106 may receive the downlink data and forward (e.g., send) the downlink data to the user device 102b. As such, the user device 102b may be connected to the first network 103 (e.g., through the network assistance device 106), despite the network assistance device 106 not being located at the premises 101.

A tunnel 312 may be established between the network assistance device 106 located outside of the premises 101 and the gateway device 104 located at the premises 101. The tunnel 312 may comprise a virtual private network (VPN) tunnel (e.g., an IPsec tunnel). The tunnel 312 may be established between the network assistance device 106 and the gateway device 104 based on the network assistance device 106 establishing a connection with the second network 122 (or the preferred network or hot spot if it is different than the second network 122). The tunnel 312 may provide a secure connection between the user device 102a and the user device 102b.

Traffic (e.g., private traffic) between the user device 102a and the user device 102b may be sent through the tunnel 312 instead of through the network 122 (or the preferred network or hot spot if it is different than the second network 122). The user device 102a may send data to the user device 102b via the tunnel 312. For example, the user device 102a may send private data to the gateway device 104. The gateway device 104 may forward (e.g., send) the private data to the network assistance device 106 via the tunnel 312. The network assistance device 106 may forward (e.g., send) the private data to the user device 102b. The user device 102b may send data to the user device 102a via the tunnel 312. For example, the user device 102b may send private data to the network assistance device 106. The network assistance device 106 may forward (e.g., send) the private data to the gateway device 104 via the tunnel 312. The gateway device 104 may forward (e.g., send) the private data to the user device 102a. Routing private traffic between the user devices 102a-b through the secure connection provided by the tunnel 312 instead of through the network 122 (or the preferred network or hot spot if it is different than the second network 122) may protect the user devices 102a-b from any security risks posed by routing the private traffic through the second network 122 (or the preferred network or hot spot if it is different than the second network 122).

The tunnel 312 may be established between the network assistance device 106 and the gateway device 104 by a controller device 304 in the first network 103. The network assistance device 106 and/or the gateway device 104 may send a message (e.g., a Transport Layer Security (TLS) handshake) to the controller device 304 in the first network 103. The network assistance device 106 may send the message to the controller device 304 via the second network 122 (or the preferred network or hot spot if it is different than the second network 122). The gateway device 104 may send the message to the controller device 304 via the computing device 108. The message sent by the network assistance device 106 and/or the gateway device 104 may comprise a message to initiate establishment of the tunnel 312 between the network assistance device 106 located outside of the premises 101 and the gateway device 104 located at the premises 101. The controller device 304 may receive the message from the network assistance device 106 and/or from the gateway device 104. The controller device 304 may establish the tunnel 312 between the network assistance device 106 and the gateway device 104 based on (e.g., in response to) receiving the message from the network assistance device 106 and/or from the gateway device 104.

A customer (e.g., client, subscriber) of the content network 103 may comprise a static IP client. The customer may, for example, comprise a business. The customer may need a reliable WAN connection to support the servers hosted with Static IP in their LAN (e.g., business LAN). The customer may use a static IP address to host web servers, mail servers, etc. However, if the gateway device at the premises of the customer is unable to establish a connection (e.g., WAN connection, DOCSIS WAN connection) with the first network 103, the web servers hosted with the static IP address may be down. If the web servers hosted with the static IP address are down, this may cause significant interruption for the customer and/or may adversely impact them financially. A network assistance device may be used to resolve this issue.

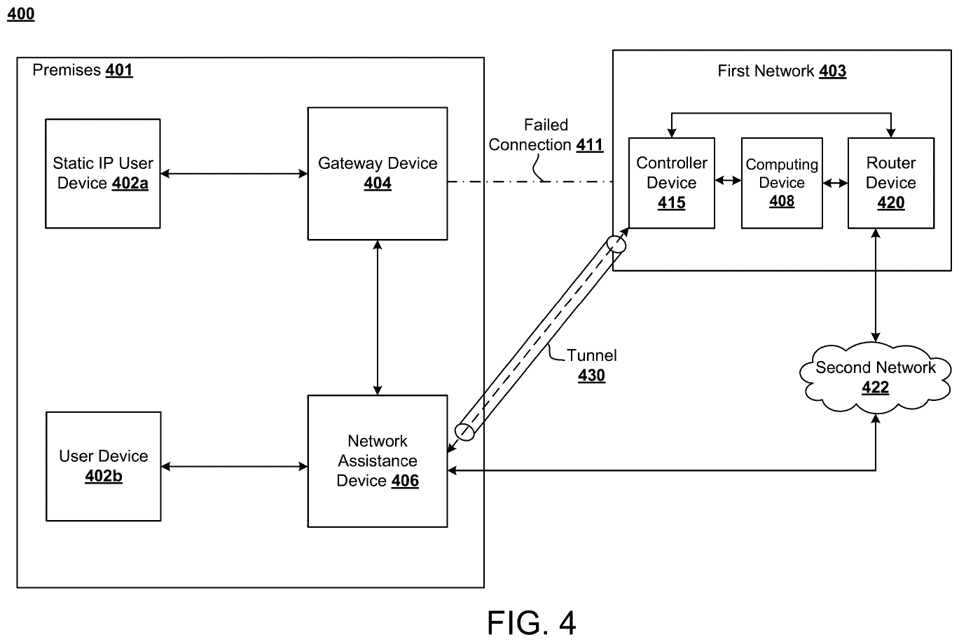

FIG. 4 is a system 400. The system 400 may comprise user devices 402a-b, a gateway device 404 (e.g., or computing device, network device, access point), a network assistance device 406 (e.g., or computing device, network device, access point), a first network 403, and a second network 422. It should be noted that while the singular term device is used herein, it is contemplated that some devices may be implemented as a single device or a plurality of devices (e.g., via load balancing). The user devices 402a-b, the gateway device 404, and the network assistance device 406 may each be implemented as one or more computing devices. Any device disclosed herein may be implemented using one or more computing nodes, such as virtual machines, executed on a single device and/or multiple devices.

The gateway device 404 may comprise a router. The gateway device 404 may comprise a modem. The gateway device 404 may be configured to provide a connection to the second network 422 via the first network 403. The first network 403 may comprise a content provider (e.g., distributor) and/or access network. The first network 403 may facilitate communication via one or more communication protocols. The first network 403 may comprise any of a variety of types of networks, such as, for example, a coaxial cable network, a fiber-optic cable network, a hybrid fiber-coaxial (HFC) network, a satellite transmission channel, a DSL connection, or the like. The first network 403 may comprise fiber, cable, a combination thereof. The first network 403 may comprise wired links, wireless links, a combination thereof, and/or the like. The first network 403 may comprise routers, switches, nodes, gateways, servers, modems, and/or the like. The second network 422 may comprise one or more networks, such as a wide area network (e.g., the Internet), a cellular network, a Long Term Evolution (LTE) network, one or more service provider networks, and/or the like. The gateway device 404 may be associated with a static IP address on the first network 403.

The first network 403 may comprise a computing device 408. The computing device 408 may comprise a cable modem termination system (CMTS), a digital subscriber line access multiplexer (DSLAM), or an optical line terminal (OLT). The computing device 408 may be located at a headend of the content provider. The computing device 408 may be configured to provide high speed data services, such as cable Internet, Voice over Internet Protocol, and/or IP video services, to user devices, such as the user devices 402a-b. The computing device 408 may be configured to provide the high speed data services to user devices 402a-b based on a connection established between the computing device 408 and the second network 422. The computing device 408 may be connected to the second network 422, such as via a router device 420.

The user devices 402a-b, the gateway device 404, and the network assistance device 406 may be located at a premises 401. The premises 401 may comprise a property, business, dwelling, terminal, building, floor, and/or the like. The premises 401 may comprise different rooms, walls, door, windows, and/or the like. The user device 402a and/or the user device 402b may move within the premises 401. The user device 402a and/or the user device 402b may be fixed at a stationary location within the premises 401. The user devices 402a-b may each comprise a computing device, a smart device (e.g., smart glasses, smart watch, smart phone), a mobile device, a tablet, a computing station, a laptop, a digital streaming device, a streaming stick, a television, and/or the like. One or more of the user devices 402a-b may be associated with a static IP address on the first network 403.

The premises 401 may include a first area within a coverage range (e.g., wireless range) of the gateway device 404. The user device 402a may be located in the first area of the premises 401. The user device 402a and the gateway device 404 may be connected, such as via a local area network (LAN). The user device 402a may be configured to send data to the gateway device 404. The gateway device 404 may be configured to receive data from the user device 402a. The gateway device 404 may be configured to send data to the user device 402a. The user device 402a may be configured to receive data from the gateway device 404.

The premises 401 may include a second area outside of the coverage range (e.g., wireless range) of the gateway device 404. If the user device 402b is located in the second area of the premises 401, the user device 402b may be unable to connect to the gateway device 404. The second area may be within a coverage range of the network assistance device 406. If the user device 402b is located in the second area of the premises 401, the user device 402b may be connected to the network assistance device 406, such as via a LAN. The user device 402b may be configured to send data to the network assistance device 406. The network assistance device 406 may be configured to receive data from the user device 402b. The network assistance device 406 may be configured to send data to the user device 402b. The user device 402b may be configured to receive data from the network assistance device 406.

The network assistance device 406 and the gateway device 404 may be connected, such as via a Wi-Fi mesh network. The gateway device 404 may be configured to send data to the network assistance device 406. The network assistance device 406 may be configured to receive data from the gateway device 404. Based on (e.g., in response to) receiving data from the gateway device 404, the network assistance device 406 may send (e.g., forward) at least a portion of the received data to the user device 402b. The network assistance device 406 may be configured to send data to the gateway device 404. The network assistance device 406 may receive data from the user device 402b and send (e.g., forward) the received data to the gateway device 404. The gateway device 404 may be configured to receive data from the network assistance device 406.

The gateway device 404 may not be connected to the first network 403. The gateway device 404 may not be connected to the first network 403 based on network condition associated with the first network 403. The network condition associated with the first network 403 may comprise a state of a connection between the gateway device 404 and the first network 403 (e.g., the computing device 408). The network condition associated with the first network 403 may indicate a failed connection 411 between the gateway device 404 and the computing device 408.

A failed connection 411 between the gateway device 404 and the computing device 408 may indicate that the gateway device 404 is unable to establish a connection (e.g., WAN connection, DOCSIS WAN connection) with the computing device 408. The gateway device 404 may be unable to establish a connection (e.g., WAN connection, DOCSIS WAN connection) with the computing device 408 based on a DOCSIS link failure. The failed connection 411 between the gateway device 404 and the computing device 408 may indicate that a previously established connection between the gateway device 404 and the computing device 408 is interrupted or broken. The failed connection 411 between the gateway device 404 and the computing device 408 may indicate that a previously established connection between the gateway device 404 and the computing device 408 is weak. The failed connection 411 may exist between the gateway device 404 and the computing device 408 if the gateway device 404 experiences a loss of power or any planned or unplanned maintenance activity at either the gateway device 404 and or the computing device 408.

The network assistance device 406 may be configured to determine the network condition associated with the first network 403. To determine the network condition associated with the first network 403, the network assistance device 406 may determine a state of the connection between the gateway device 404 and the first network 403. To determine a state of the connection between the gateway device 404 and the first network 403, the network assistance device 406 may send a message (e.g., signal, heartbeat) to the gateway device 404. Based on (e.g., in response to) sending the message to the gateway device 404, the network assistance device 406 may wait to receive a response message (e.g., response signal, heartbeat) from the gateway device 404. If the network assistance device 406 receives a response message from the gateway device 404, such as within a predetermined amount of time, the network assistance device 406 may determine the failed connection 411 between the gateway device 404 and the computing device 408. The predetermined amount of time may be any number of minutes, seconds, or milliseconds, such as 500 milliseconds, one second, two seconds, etc. Conversely, if the network assistance device 406 does not receive a response message from the gateway device 404, such as within a predetermined amount of time, the network assistance device 406 may determine the failed connection 411 between the gateway device 404 and the computing device 408.

The network assistance device 406 may be configured to establish a connection with the second network 422. The network assistance device 406 may be configured to establish a connection with the second network 422 based on (e.g., in response to) the network condition associated with the first network 403. The network assistance device 406 may be configured to establish a connection with the second network 422 based on (e.g., in response to) a state of the connection between the gateway device 404 and the first network 403. For example, the network assistance device 406 may be configured to establish a connection with the second network 422 based on determining the failed connection 411 between the gateway device 404 and the computing device 408. As described above, the second network 422 may comprise one or more networks, such as a wide area network (e.g., the Internet), a cellular network, an LTE network, one or more service provider networks, and/or the like. The network assistance device 406 may connect to the second network 422 via a wireless access point (e.g., a cellular tower, etc.). The wireless access point may be connected to a WAN, such as a WAN comprising the first network 403. The network assistance device 406 may be associated with a second IP address on the second network 422.

A tunnel 430 may be established between the network assistance device 406 and a controller device 415 associated with the first network 403. Though FIG. 4 shows the tunnel being between the network assistance device 406 and the controller device 415, it should be understood that the tunnel 430 may travel through the second network 422. The tunnel 430 may comprise a virtual private network (VPN) tunnel (e.g., an IPsec tunnel). The network assistance device 406 may cause establishment of the tunnel 430. The network assistance device 406 may cause establishment of the tunnel 430 by sending a message to initiate establishment of the tunnel 430 to the controller device 415. The network assistance device 406 may send the message to initiate establishment of the tunnel 430 to the controller device 415 via the second network 422. The controller device 415 may receive the message. Based on (e.g., in response to) receiving the message, the controller device 415 may establish the tunnel 430 between the network assistance device 406 and the controller device 415. Based on (e.g., in response to) establishing the tunnel 430, the controller device 415 may send data indicative of the static IP address associated with the user device(s) 402a-b to the network assistance device 406.

The connection between one or more of user device(s) 402a-b and the first network 403 may be reestablished. The connection between one or more of user device(s) 402a-b and the first network 403 may be reestablished by the network assistance device 406 via the second network 422. The connection between one or more of user device(s) 402a-b and the first network 403 may be reestablished based on the static IP address. Thus, the user device(s) 402a-b may maintain the static IP address despite being unable to establish a connection to the first network 403 via the gateway device 404.

The tunnel 430 may be configured to route data to and from the network assistance device 406 address based on the static IP address. The network assistance device 406 may be configured to send a message indicating that the controller device 415 can route data to the static IP address using the tunnel 430. The network assistance device 406 may send the message to the controller device 415 via the established tunnel 430. RIPv2 protocol support may be added into the network assistance device 406 on the IPsec interface to advertise the static IP block to the controller device 415.

Traffic (e.g., static IP traffic, data) may be routed through the tunnel 430. Data addressed to the static IP address may be routed through the network assistance device via the tunnel 430. The router device 420 may send a packet (e.g., downlink data) to the controller device 415. The original header of the packet may indicate that the packet is addressed to the static IP address. The controller device 415 may cause the packet to be sent through the tunnel 430. The tunnel 430 may encrypt the packet. To encrypt the packet, the tunnel 430 may wrap (e.g., encapsulate) the packet in a new packet. Wrapping the packet in the new packet may encrypt the original header indicating that the packet is addressed to the static IP address. The tunnel 430 may add a new header to the wrapped packet. The new header may indicate that the wrapped packet is to be sent to the network assistance device 406. The network assistance device 406 may receive the wrapped packet. Thus, the network assistance device 406 may receive data addressed to the static IP address. The network assistance device 406 may decrypt the wrapped packet. The network assistance device 406 may send (e.g., forward) the decrypted packet to one or more of the user device(s) 402a-b associated with the static IP address. The network assistance device 406 may send (e.g., forward) the decrypted packet to a user device associated with the static IP address via the second network. The network assistance device 406 may send (e.g., forward) the decrypted packet to the user device 402b and/or the user device 402a (such as via the gateway device 404).

Data sent from one or more of the user device(s) 402a-b associated with a static IP address may be forwarded from the network assistance device via the tunnel. The network assistance device 406 may receive a packet (e.g., uplink data) from the user device 402b or from the user device 402a (such as via the gateway device 404). The network assistance device 406 may cause the packet to be sent through the tunnel 430. The tunnel 430 may wrap (e.g., encapsulate) the packet in a new packet. Wrapping the packet in the new packet may encrypt an original header associated with the packet. The tunnel 430 may add a new header to the wrapped packet. The new header may indicate that the wrapped packet is to be forwarded (e.g., sent) from the static IP address. The controller device 415 may receive the wrapped packet. The controller device 415 may decrypt the wrapped packet. The controller device 415 may cause the packet to be forward to the intended recipient from the static IP address via the first network 403. Thus, the network assistance device 406 may cause data to be forwarded from the static IP address.

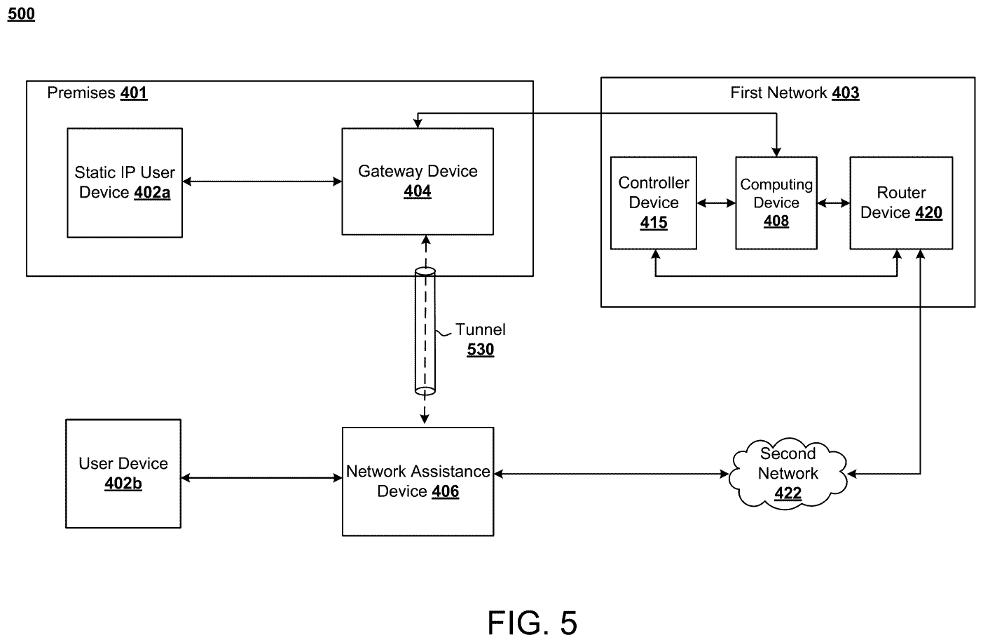

If the network assistance device 406 is located external to the premises 401, a tunnel may be established between the network assistance device 406 and the gateway device 404 instead of between the network assistance device 406 and the controller device 415. FIG. 5 is an example system 500. The system 500 may comprise the user devices 402a-b. One or more of the user devices 402a-b may be static IP clients. The system 500 may comprise the gateway device 404, the network assistance device 406, the first network 403, and the second network 422. The user device 402a and the gateway device 404 may be located at the premises 401. However, the user device 402b and the network assistance device 406 may not be located at the premises 401. The user device 402b and the network assistance device 406 may be located at a second, different premises. The different premises may comprise a property, dwelling, terminal, building, floor, and/or the like. The different premises may be outdoors. The different premises may be in a public location (e.g., park, restaurant, cafe, etc.). The user device 402b and the network assistance device 406 may be in transit (e.g., traveling to or from the first premises 401).

The user device 402a may be connected to the first network 403 via the gateway device 404. The user device 402a may send uplink data to the computing device 408 via the gateway device 404. To send uplink data to the computing device 408, the user device 402a may send uplink data to the gateway device 404. The gateway device 404 may receive the uplink data and forward (e.g., send) the uplink data to the computing device 408. The user device 402a may receive downlink data from the computing device 408 via the gateway device 404. The computing device 408 may send downlink data to the gateway device 404. The gateway device 404 may receive the downlink data and forward (e.g., send) the downlink data to the user device 402a.

The network assistance device 406 may be configured to determine whether the network assistance device 406 is located at the premises 401. To determine whether the network assistance device 406 is located at the premises 401, the network assistance device 406 may send a message (e.g., signal, heartbeat) to the gateway device 404. Based on (e.g., in response to) sending the message to the gateway device 404, the network assistance device 406 may wait to receive a response message (e.g., response signal, heartbeat) from the gateway device 404. If the network assistance device 406 receives a response message from the gateway device 404, such as within a predetermined amount of time, the network assistance device 406 may determine that the network assistance device 406 is located at the premises 401. The predetermined amount of time may be any number of minutes, seconds, or milliseconds, such as 500 milliseconds, one second, two seconds, etc. If the network assistance device 406 does not receive a response message from the gateway device 404, such as within a predetermined amount of time, the network assistance device 406 may determine that the network assistance device 406 is not located at the premises 401.

To determine whether the network assistance device 406 is located at the premises 401, the network assistance device may use geolocation. The network assistance device 406 may determine geolocation data (e.g., latitude and longitude coordinates) associated with the network assistance device 406. The network assistance device 406 may determine the geolocation data using any combination of suitable geolocation techniques, such as one or more of Global Positioning System (GPS), Enhanced Observed Time Difference (E-OTD), Enhanced GPS (E-GPS), Wi-Fi, and/or Bluetooth. The network assistance device 406 may compare the geolocation data associated with the network assistance device 406 to known geolocation data associated with the gateway device 404 and/or the premises 401 to determine whether the network assistance device 406 is located at the premises 401 or not.

The network assistance device 406 may use geolocation data in addition to, or as an alternative to, the heartbeat message to determine whether the network assistance device 406 is located at the premises 401. Using geolocation data to determine or verify whether the network assistance device 406 is located at the premises 401 may prevent the network assistance device 406 from falsely determining that the network assistance device 406 is not located at the premises 401 based on a weak or intermittent connection between the network assistance device 406 and the gateway device 404.

The network assistance device 406 may be configured to establish a connection with the second network 422. The network assistance device 406 may be configured to establish a connection with the second network 422 based on (e.g., in response to) determining that the network assistance device 406 is not located at the premises 401. As described above, the second network 422 may comprise one or more networks, such as a wide area network (e.g., the Internet), a cellular network, an LTE network, one or more service provider networks, and/or the like. The network assistance device 406 may connect to the second network 422 via a wireless access point (e.g., a cellular tower). The wireless access point may be connected to a WAN, such as a WAN comprising the first network 403.

A tunnel 530 may be established between the network assistance device 406 located external to the premises 401 and the gateway device 404 located at the premises 401. The tunnel 530 may travel through the second network 422. The tunnel 530 may comprise a virtual private network (VPN) tunnel (e.g., an IPsec tunnel). The network assistance device 406 may cause establishment of the tunnel 530. The network assistance device 406 may cause establishment of the tunnel 530 by sending a message to initiate establishment of the tunnel 530 to the controller device 415. The network assistance device 406 may send the message to initiate establishment of the tunnel 530 to the controller device 415 via the second network 422. The controller device 415 may receive the message. Based on (e.g., in response to) receiving the message, the controller device 415 may establish the tunnel 530 between the network assistance device 406 and the gateway device 404. If the user device 402b is associated with a static IP address, based on (e.g., in response to) establishing the tunnel 430, the controller device 415 may send data indicative of the static IP address associated with the user device(s) 402b to the network assistance device 406.

The network assistance device 406 may receive, via the tunnel, data indicative of the static IP address. The connection between the user device 402b and the first network 403 may be established or reestablished. The connection between the user device 402b and the first network 403 may be established or reestablished by the network assistance device 406 via the second network. The connection between the user device 402b and the first network 403 may be established or reestablished based on the static IP address. Thus, the user device may maintain the static IP address despite being unable to establish a connection to the first network 403 via the gateway device 404.

The tunnel 530 may be configured to route data to and from the network assistance device 406 based on the static IP address. The tunnel 530 may be configured to route data to and from the network assistance device 406 through the gateway device 404. The network assistance device 406 may be configured to send a message to the controller device 415 indicating that the tunnel 530 may be used to route data to the static IP address. RIPv2 protocol support may be added into the network assistance device 406 on the IPsec interface to advertise the static IP block to the controller device 415. The controller device 415 may determine that the gateway device is connected to the computing device 408. Based on determining that the gateway device is connected to the computing device 408, the controller device 415 may not publish a RIP update associated with the network assistance device 406 to the upstream network.

Traffic (e.g., static IP traffic, data) to and from the user device 402b may be routed through the tunnel 530 (e.g., instead of through the second network 422). By routing traffic to and from the user device 402b through the tunnel 530 instead of through the second network 422, the user device 402b may be able to maintain the static IP address. Thus, the tunnel 530 may effectively cause the user device 402b to appear to be located at the premises 410, such as to one or more services provided by the first network 403.

A packet may be received at the gateway device 404. The original header of the packet may indicate that the packet is addressed to the static IP address. The gateway device 404 may cause the packet to be sent through the tunnel 530. The tunnel 530 may encrypt the packet. To encrypt the packet, the tunnel 530 may wrap (e.g., encapsulate) the packet in a new packet. Wrapping the packet in the new packet may encrypt the original header. The tunnel 530 may add a new header to the wrapped packet. The new header may indicate that the wrapped packet is to be sent to the static IP address. The network assistance device 406 may receive the wrapped packet. The network assistance device 406 may decrypt the wrapped packet. The network assistance device 406 may send (e.g., forward) the decrypted packet to a user device associated with the static IP address, such as the user device 402b.

The user device 402b may send a packet to the network assistance device 406. The network assistance device 406 may receive the packet. The original header of the packet may indicate that the packet is sent from the static IP address. The network assistance device 406 may cause the packet to be sent through the tunnel 530. The tunnel 530 may wrap (e.g., encapsulate) the packet in a new packet. Wrapping the packet in the new packet may encrypt the original header indicating that the packet is sent from the static IP address. The tunnel 530 may add a new header to the wrapped packet. The new header may indicate that the wrapped packet is to be forwarded (e.g., sent) from the static IP address. The gateway device 404 may receive the wrapped packet. The gateway device 404 may decrypt the wrapped packet. The gateway device 404 may cause the packet to be forwarded to the intended recipient from the static IP address.

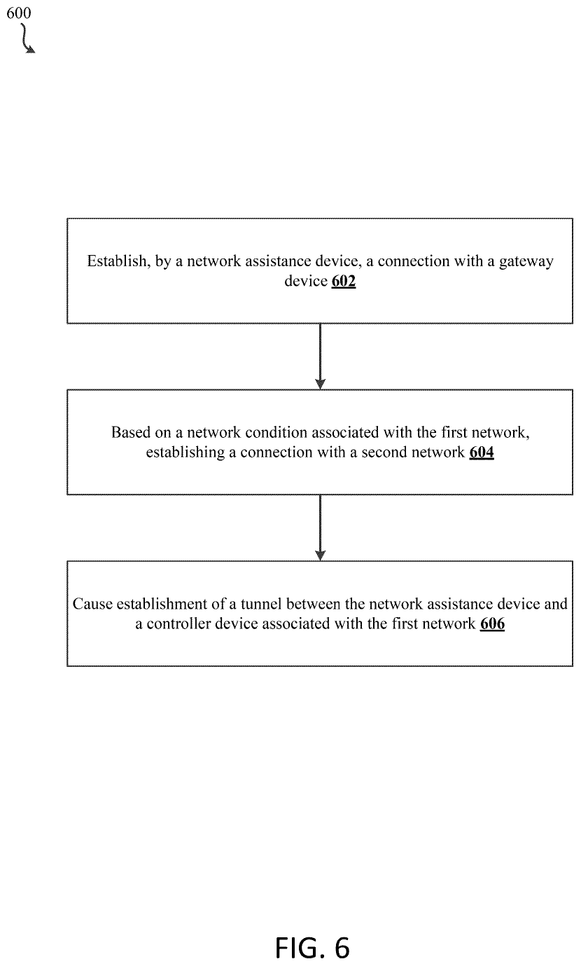

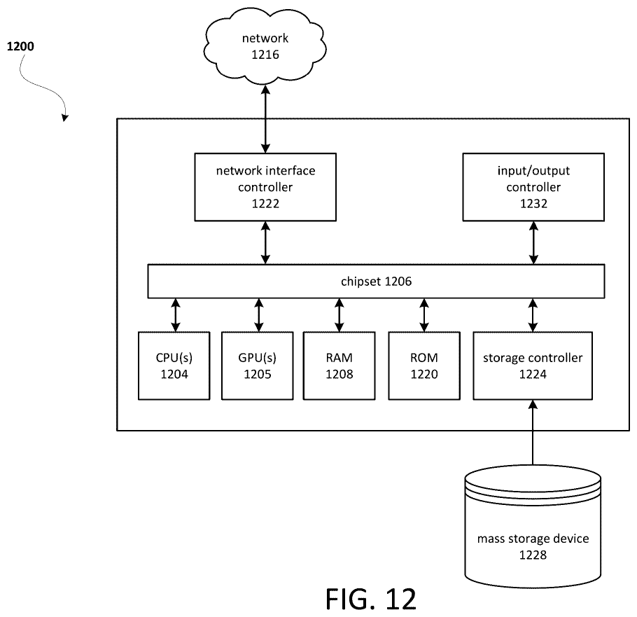

FIG. 6 is an example method 600. The method 600 may comprise a computer implemented method for connection management. A system and/or computing environment, such as the system 400 of FIG. 4 and/or the computing environment of FIG. 12, may be configured to perform the method 600. For example, the network assistance device 406 of FIG. 4 may be configured to perform the method 600.

At 602, a connection may be established. The connection may be established by a network assistance device (e.g., or computing device, network device, access point). The connection may be established between the network assistance device and a gateway device (e.g., or computing device, network device, access point). The gateway device may be located at a premises. The network assistance device may be located at the premises. The gateway device may be associated with a static IP address on a first network. The static IP address may be a static IP address. The gateway device may be associated with a static IP address client on the first network. The first network may comprise a content provider (e.g., distributor) and/or access network.

At 604, a connection may be established. The connection may be established by the network assistance device. The connection may be established between the network assistance device and a second network. The connection may be established based on a network condition associated with the first network. The connection may be established based on a network condition associated with the first network through the gateway device. The network assistance device may be associated with a second IP address on the second network. The second network may comprise one or more networks, such as a wide area network (e.g., the Internet), a cellular network, a Long Term Evolution (LTE) network, one or more service provider networks, and/or the like. The network assistance device may connect to the second network via a wireless access point (e.g., a cellular tower, etc.). The wireless access point may be connected to a WAN, such as a WAN comprising the first network.

The network condition associated with the first network may comprise a state of a connection between the gateway device and the first network. The network condition associated with the first network may comprise a state of a connection between the gateway device and a computing device associated with the first network. The state of the connection between the gateway device and the first network may indicate that the gateway device is unable to establish a connection (e.g., WAN connection, DOCSIS WAN connection) with the first network. The connection may be established based on the gateway device being unable to establish a connection (e.g., WAN connection, DOCSIS WAN connection) with the first network. The state of the connection between the gateway device and the first network may indicate that the connection between the gateway device and the first network is weak and/or interrupted. The connection may be established based on the connection between the gateway device and the first network being weak and/or interrupted.

At 606, establishment of a tunnel may be caused. The tunnel may be caused to be established between the network assistance device and a controller device. The controller device may be associated with the first network. The tunnel may comprise a virtual private network (VPN) tunnel (e.g., an IPsec tunnel). Establishment of the tunnel may be caused by sending a message to initiate establishment of the tunnel to the controller device. The controller device may receive the message. Based on (e.g., in response to) receiving the message, the controller device may establish the tunnel between the network assistance device and the controller device.

The tunnel may be configured to route data to the static IP address. Data addressed to the static IP address may be routed to the network assistance device via the tunnel. A packet may be received by the controller device. The original header of the packet may indicate that the packet is addressed to the static IP address. The controller device may cause the packet to be sent through the tunnel. The tunnel may encrypt the packet. To encrypt the packet, the tunnel may wrap (e.g., encapsulate) the packet in a new packet. Wrapping the packet in the new packet may encrypt the original header indicating that the packet is addressed to the static IP address. The tunnel may add a new header to the wrapped packet. The new header may indicate that the wrapped packet is to be sent to the network assistance device. The network assistance device may receive the wrapped packet. The network assistance device may forward the data associated with the unwrapped packet to one or more user devices associated with the first IP address. Thus, the network assistance device may receive, decrypt, and/or forward data addressed to the static IP address.

The tunnel may be configured to route data from the first IP address. Data sent from the first IP address may be forwarded via the tunnel. The network assistance device associated with the second IP address may receive an uplink packet. The original header of the packet may indicate that the packet is sent from the first IP address. The network assistance device may cause the packet to be sent through the tunnel. The tunnel may wrap (e.g., encapsulate) the packet in a new packet. Wrapping the packet in the new packet may encrypt the original header indicating that the packet is sent from the first IP address. The tunnel may add a new header to the wrapped packet. The new header may indicate that the wrapped packet is to be forwarded (e.g., sent) from the network assistance device. The controller device may receive the wrapped packet. The controller device may decrypt the wrapped packet. The controller device may cause the packet to be forward to the intended recipient from the first IP address. Thus, the network assistance device associated with the second IP address may cause data to be forwarded to the intended recipient from the static IP address.

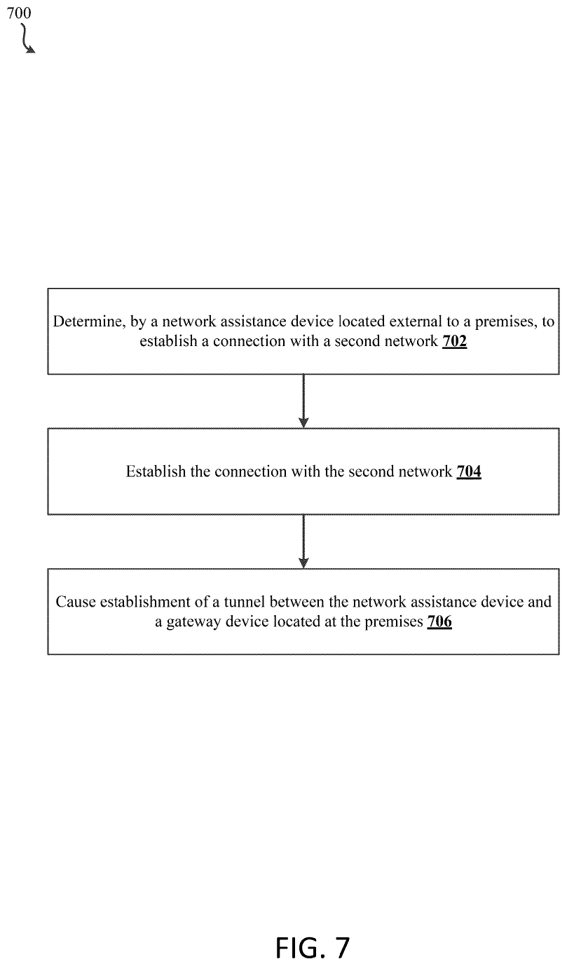

FIG. 7 is an example method 700. The method 700 may comprise a computer implemented method for connection management. A system and/or computing environment, such as the system 500 of FIG. 5 and/or the computing environment of FIG. 12, may be configured to perform the method 700. For example, the network assistance device 406 of FIG. 5 may be configured to perform the method 700.

At 702, a network assistance device (e.g., or computing device, network device, access point) may determine to establish a connection with a second network. The second network may comprise one or more networks, such as a wide area network (e.g., the Internet), a cellular network, a Long Term Evolution (LTE) network, one or more service provider networks, and/or the like. The network assistance device may be located external to a premises. The premises may comprise a gateway device (e.g., or computing device, network device, access point). The gateway device may be associated with a first Internet Protocol (IP) address on a first network. The first IP address may comprise a static IP address. The first network may comprise a content provider (e.g., distributor) and/or access network.

It may be determined to establish the connection between the network assistance device and the second network based on (e.g., in response to) determining that the network assistance device is not located at the premises. To determine whether the network assistance device is located at the premises, a message (e.g., signal, heartbeat) may be sent from the network assistance device. The message may be sent to the gateway device. If a response message is not received at the network assistance device from the gateway device, such as within a predetermined amount of time, it may be determined that the network assistance device is not located at the premises. The predetermined amount of time may be any number of minutes, seconds, or milliseconds, such as 500 milliseconds, one second, two seconds, etc. Geolocation may additionally, or alternatively, be used to determine whether the network assistance device is located at the premises.

At 704, the connection may be established. The connection may be established by the network assistance device. The connection may be established between the network assistance device and the second network. The network assistance device may be associated with a second IP address on the second network. The second IP address may comprise a static IP address. The network assistance device may connect to the second network via a wireless access point (e.g., a cellular tower, etc.). The wireless access point may be connected to a WAN, such as a WAN comprising the first network.

At 706, establishment of a tunnel may be caused. The tunnel may be caused to be established between the network assistance device and the gateway device. The tunnel may comprise a virtual private network (VPN) tunnel (e.g., an IPsec tunnel). Establishment of the tunnel may be caused by sending a message to initiate establishment of the tunnel to a controller device. The controller device may be associated with the first network. The controller device may receive the message. Based on (e.g., in response to) receiving the message, the controller device may establish the tunnel between the network assistance device and the gateway device.

The tunnel may be configured to route data to and from the network assistance device (e.g., via the gateway device). The tunnel may be configured to route data to the network assistance device local network from the gateway device local network, and vice versa.

The network assistance device may be configured to receive, via the established tunnel and from the gateway device, data addressed to the second IP address. A packet may be received at the gateway device. The original header of the packet may indicate that the packet is addressed to the second IP address. The gateway device may cause the packet to be sent through the tunnel. The tunnel may encrypt the packet. To encrypt the packet, the tunnel may wrap (e.g., encapsulate) the packet in a new packet. Wrapping the packet in the new packet may encrypt the original header indicating that the packet is addressed to the second IP address. The tunnel may add a new header to the wrapped packet. The new header may indicate that the wrapped packet is to be sent to the second IP address and/or to the network assistance device. The network assistance device may receive the wrapped packet. The network assistance device may decrypt the wrapped packet. The network assistance device may send (e.g., forward) the decrypted packet to one or more user devices (e.g., user devices associated with the second IP address).

The network assistance device may be configured to send, via the established tunnel and to the gateway device, data. The network assistance device may receive a packet, such as from a user device (e.g., a user device associated with the second IP address). The original header of the packet may indicate that the packet is sent from the second IP address. The network assistance device may cause the packet to be sent through the tunnel. The tunnel may wrap (e.g., encapsulate) the packet in a new packet. Wrapping the packet in the new packet may encrypt the original header indicating that the packet is sent from the second IP address. The tunnel may add a new header to the wrapped packet. The new header may indicate that the wrapped packet is to be forwarded (e.g., sent) to the gateway device. The new header may indicate that the wrapped packet is to be forwarded (e.g., sent) from the second IP address. The gateway device may receive the wrapped packet. The gateway device may decrypt the wrapped packet. The gateway device may cause the packet to be forward to the intended recipient (e.g., a user device associated with the first IP address). The gateway device may cause the packet to be forward to the intended recipient from the second IP address.

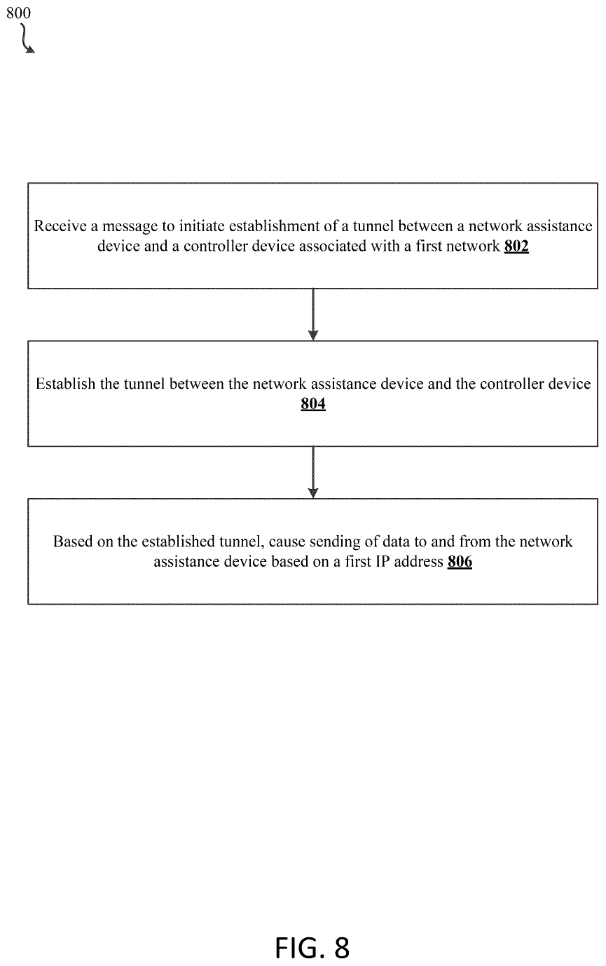

FIG. 8 is an example method 800. The method 800 may comprise a computer implemented method for connection management. A system and/or computing environment, such as the system 400 of FIG. 4 and/or the computing environment of FIG. 12, may be configured to perform the method 800. For example, the controller device 415 of FIG. 4 may be configured to perform the method 800.

At 802, a message may be received. The message may be received at a controller device associated with a first network. The message may be received from a network assistance device (e.g., or computing device, network device, access point). The message may be a message to initiate establishment of a tunnel between the network assistance device and the controller device. The network assistance device may be associated with a second IP address on a second network. The network assistance device may be connected to a gateway device (e.g., or computing device, network device, access point). The gateway device may be associated with a first IP address on the first network. The gateway device may be located at a premises. The network assistance device may be located at the same premises.

At 804, the tunnel may be established. The tunnel may be established between the network assistance device and the controller device. The tunnel may comprise a virtual private network (VPN) tunnel (e.g., an IPsec tunnel). The tunnel may be configured to route data to and from the network assistance device.

At 806, sending of data to and from the second IP address may be caused. The sending of data to and from the second IP address may be caused based on the established tunnel.

Data addressed to the static IP address may be routed through the network assistance device via the tunnel. A packet may be received by the controller device. The original header of the packet may indicate that the packet is addressed to the static IP address. The controller device may cause the packet to be sent through the tunnel. The tunnel may encrypt the packet. To encrypt the packet, the tunnel may wrap (e.g., encapsulate) the packet in a new packet. Wrapping the packet in the new packet may encrypt the original header indicating that the packet is addressed to the static IP address. The tunnel may add a new header to the wrapped packet. The new header may indicate that the wrapped packet is to be sent to the network assistance device. The network assistance device may receive the wrapped packet. Thus, the network assistance device associated with the second IP address may receive data addressed to the static IP address. The network assistance device may forward the received data to one or more user devices associated with the static IP address, such as via the gateway 404.

Data sent from the second IP address may be forwarded from the network assistance device via the tunnel. The network assistance device may receive an uplink packet (e.g., from a user device). The original header of the packet may indicate that the packet is sent from either the first or second IP address. The network assistance device may cause the packet to be sent through the tunnel. The tunnel may wrap (e.g., encapsulate) the packet in a new packet. Wrapping the packet in the new packet may encrypt the original header. The tunnel may add a new header to the wrapped packet. The new header may indicate that the wrapped packet is to be forwarded (e.g., sent) from the first or second (e.g., static) IP address. The controller device may receive the wrapped packet. The controller device may decrypt the wrapped packet. The controller device may cause the packet to be forward to the intended recipient from the second or first IP address via the first network.

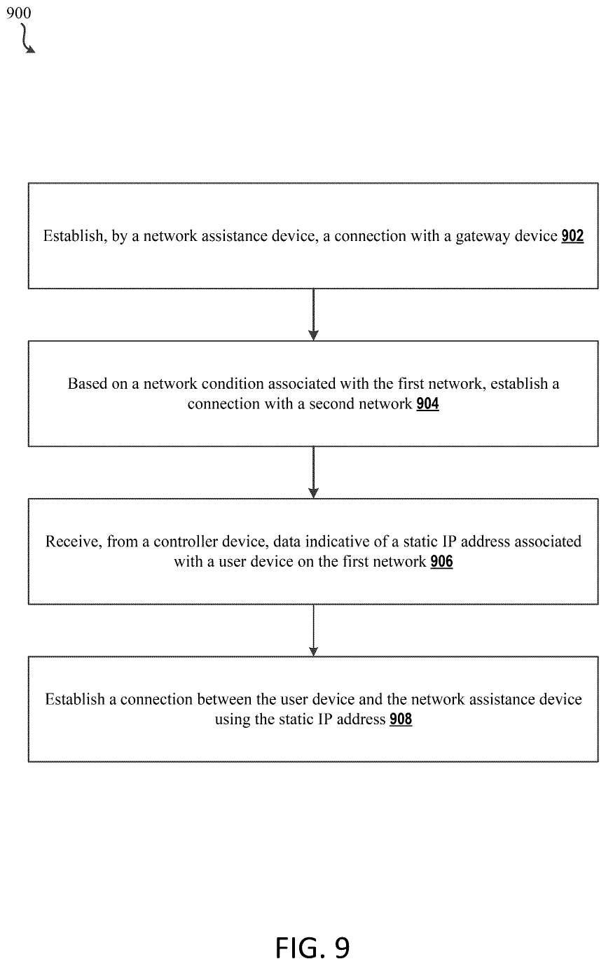

FIG. 9 is an example method 900. The method 900 may comprise a computer implemented method for connection management. A system and/or computing environment, such as the system 400 of FIG. 4 and/or the computing environment of FIG. 12, may be configured to perform the method 900. For example, the network assistance device 406 of FIG. 4 may be configured to perform the method 900.

At 902, a connection with a gateway device may be established. The connection with the gateway device may be established by a network assistance device (e.g., computing device, network device, access point). The gateway device may be located at a premises. The network assistance device may be located at the premises. A user device may be connected to a first network via the gateway device. The user device may be associated with a static IP address on the first network. The first network may comprise a content provider (e.g., distributor) and/or access network.

At 904, a connection may be established. The connection may be established by the network assistance device. The connection may be established between the network assistance device and a second network. The connection may be established based on a network condition associated with the first network. The connection may be established based on a network condition associated with the first network through the gateway device. The second network may comprise one or more networks, such as a wide area network (e.g., the Internet), a cellular network, an LTE network, one or more service provider networks, and/or the like. The network assistance device may connect to the second network via a wireless access point (e.g., a cellular tower, etc.). The wireless access point may be connected to a WAN, such as a WAN comprising the first network.

The network condition associated with the first network may comprise a state of a connection between the gateway device and the first network. The network condition associated with the first network may comprise a state of a connection between the gateway device and a computing device associated with the first network. The state of the connection between the gateway device and the first network may indicate that the gateway device is unable to establish a connection (e.g., WAN connection, DOCSIS WAN connection) with the first network. The connection may be established based on the gateway device being unable to establish a connection (e.g., WAN connection, DOCSIS WAN connection) with the first network. The state of the connection between the gateway device and the first network may indicate that the connection between the gateway device and the first network is weak and/or interrupted. The connection may be established based on the connection between the gateway device and the first network being weak and/or interrupted.

At 906, data indicative of the static IP address associated with the user device may be received. The data indicative of the static IP address associated with the user device may be received from a controller device. The controller device may be associated with the first network. The data indicative of the static IP address associated with the user device may be received by the network assistance device. The data indicative of the static IP address may comprise one or more of data indicating the user device is associated with the static IP address, data indicating an assignment of the static IP address to the user device, data comprising instructions to assign the static IP address to the user device, and/or the like. A tunnel may be caused to be established between the network assistance device and the controller device associated with the first network. Causing establishment of the tunnel between the network assistance device and the controller device associated with the first network may comprise sending, to the controller device, a message to initiate establishment of the tunnel. The tunnel may comprise an Internet Protocol Security (IPsec) tunnel. Receiving the data indicative of the static IP address may comprise receiving the data indicative of the static IP address via the tunnel.

At 908, a connection between the user device and the network assistance device may be established. Establishment of the connection between the user device and the network assistance device may be caused based on (e.g., using) the static IP address. Data may be routed to and from the network assistance device address based on the static IP address. The controller device may route data addressed to the static IP address, such as through the tunnel. The network assistance device may receive the data addressed to the static IP address. The network assistance device may send (e.g., forward) the data to the user device associated with the static IP address. Thus, the user device may maintain the static IP address despite being unable to establish a connection to the first network.

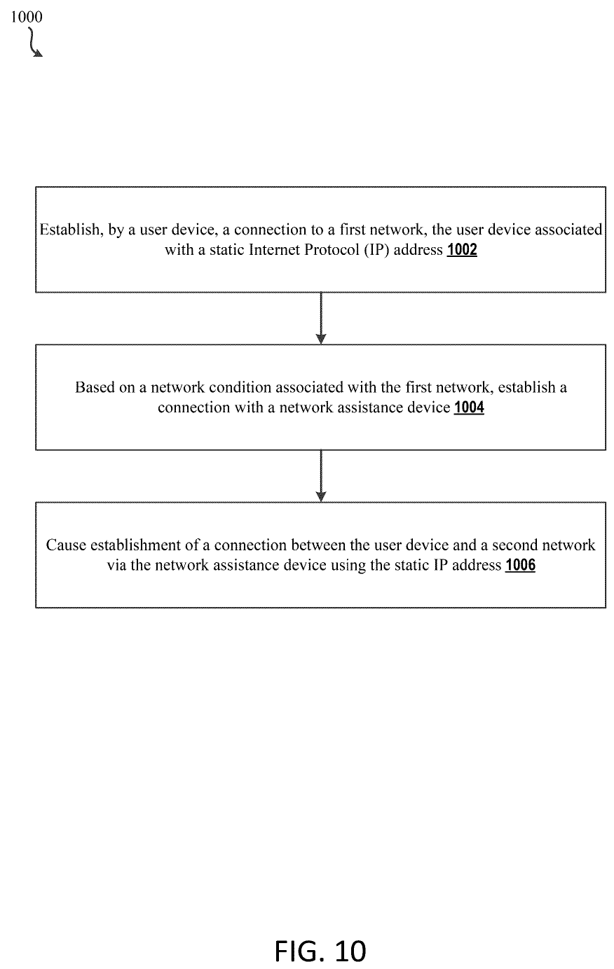

FIG. 10 is an example method 1000. The method 1000 may comprise a computer implemented method for connection management. A system and/or computing environment, such as the system 400 of FIG. 4 and/or the computing environment of FIG. 12, may be configured to perform the method 1000. For example, the user device 402a of FIG. 4 may be configured to perform the method 1000.

At 1002, a connection to a first network may be established. The connection to the first network may be established by a user device. The connection to the first network may be established via a gateway device. The gateway device may be located at a premises. The user device may be associated with a static IP address on the first network. The first network may comprise a content provider (e.g., distributor) and/or access network.

At 1004, a connection with a network assistance device may be established. The connection with the network assistance device may be established by the user device. The connection with the network assistance device may be established based on a network condition associated with the first network. The network condition associated with the first network may comprise a state of a connection between the gateway device and the first network. The network condition associated with the first network may comprise a state of a connection between the gateway device and a computing device associated with the first network. The state of the connection between the gateway device and the first network may indicate that the gateway device is unable to establish a connection (e.g., WAN connection, DOCSIS WAN connection) with the first network. The connection may be established based on the gateway device being unable to establish a connection (e.g., WAN connection, DOCSIS WAN connection) with the first network. The state of the connection between the gateway device and the first network may indicate that the connection between the gateway device and the first network is weak and/or interrupted. The connection may be established based on the connection between the gateway device and the first network being weak and/or interrupted.

The network assistance device may be associated with and/or connected to a second network. The second network may comprise at least one of a cellular network or an LTE network. At 1006, establishment of a connection between the user device and the second network may be caused. Establishment of the connection between the user device and the second network may be caused via the network assistance device. Establishment of the connection between the user device and the second network may be caused using the static IP address. The network assistance device may be configured to cause establishment of a tunnel between the network assistance device and a controller device, such as a controller device associated with the first network. The network assistance device may be configured to receive data indicative of the static IP address via the tunnel. The tunnel may comprise an Internet Protocol Security (IPsec) tunnel. Data may be routed to and from the network assistance device based on the static IP address, such as via the tunnel. The controller device may route data addressed to the static IP address to the network assistance device, such as via the tunnel. The network assistance device may receive the data addressed to the static IP address. The network assistance device may send (e.g., forward) the data to the user device associated with the static IP address. Thus, the user device may maintain the static IP address despite being unable to establish a connection to the first network.

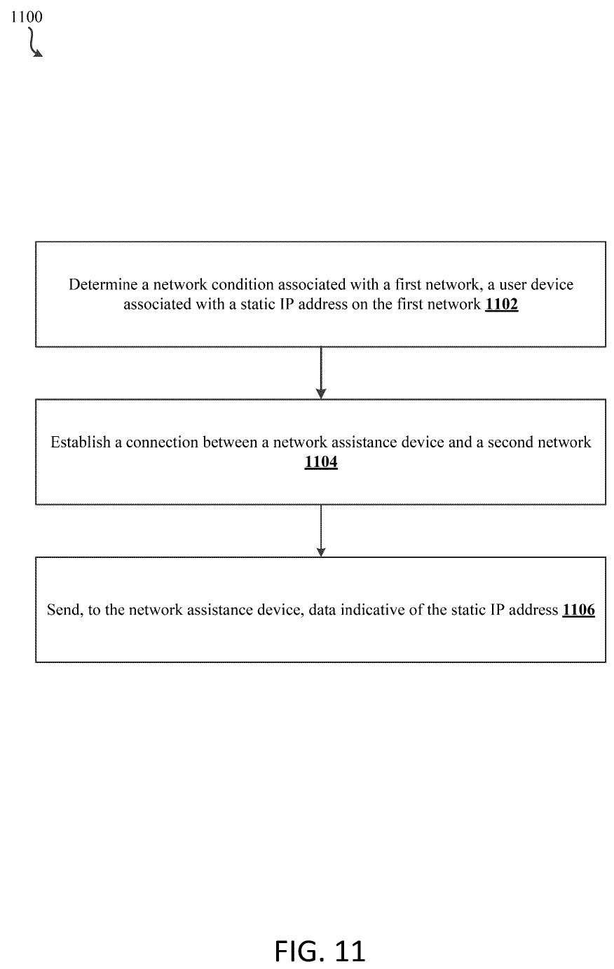

FIG. 11 is an example method 1100. The method 1100 may comprise a computer implemented method for connection management. A system and/or computing environment, such as the system 400 of FIG. 4 and/or the computing environment of FIG. 12, may be configured to perform the method 1100. For example, the controller device 415 of FIG. 4 may be configured to perform the method 1100.

At 1102, a network condition may be determined. The network condition may be associated with a first network. A user device may be associated with a static IP address on the first network. The network condition associated with the first network may comprise a state of a connection between a gateway device and the first network. The network condition associated with the first network may comprise a state of a connection between the gateway device and a computing device associated with the first network. The state of the connection between the gateway device and the first network may indicate that the gateway device is unable to establish a connection (e.g., WAN connection, DOCSIS WAN connection) with the first network. The state of the connection between the gateway device and the first network may indicate that the connection between the gateway device and the first network is weak and/or interrupted.

At 1104, a connection may be established between a network assistance device and a second network. The second network may comprise at least one of a cellular network or an LTE network. The connection between the network assistance device and the second network may be established based on the network condition associated with the first network. The connection between the network assistance device and the second network may be established based on the network assistance device being unable to connect to the first network via the gateway device.

At 1106, data indicative of the static IP address may be sent. The data indicative of the static IP address may be sent to the network assistance device. The network assistance device may be connected to a second network. The network assistance device may be configured to cause establishment of a connection between the user device and the second network. Establishment of the connection between the user device and the second network may be caused using the static IP address. The network assistance device may be configured to cause establishment of a tunnel between the network assistance device and a controller device. The network assistance device may be configured to receive data indicative of the static IP address via the tunnel. The tunnel may comprise an Internet Protocol Security (IPsec) tunnel. Data may be routed to and from the network assistance device address based on the static IP address, such as via the tunnel. The controller device may route data addressed to the static IP address to the network assistance device, such as via the tunnel. The network assistance device may receive the data addressed to the static IP address. The network assistance device may send (e.g., forward) the data to the user device associated with the static IP address. Thus, the user device may maintain the static IP address despite being unable to establish a connection to the first network.

FIG. 12 depicts a computing device that may be used in various aspects, such as the servers and/or devices depicted in FIG. 1. With regard to the example architecture of FIGS. 1-5, any of the components or devices may each be implemented in an instance of a computing device 1200 of FIG. 12.

The computer architecture shown in FIG. 12 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIGS. 6-11.

The computing device 1200 may include a baseboard, or “motherboard,” which is a printed circuit board to which a multitude of components or devices may be connected by way of a system bus or other electrical communication paths. One or more central processing units (CPUs) 1204 may operate in conjunction with a chipset 1206. The CPU(s) 1204 may be standard programmable processors that perform arithmetic and logical operations necessary for the operation of the computing device 1200.

The CPU(s) 1204 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1204 may be augmented with or replaced by other processing units, such as GPU(s) 1205. The GPU(s) 1205 may comprise processing units specialized for but not necessarily limited to highly parallel computations, such as graphics and other visualization-related processing.

A chipset 1206 may provide an interface between the CPU(s) 1204 and the remainder of the components and devices on the baseboard. The chipset 1206 may provide an interface to a random access memory (RAM) 1208 used as the main memory in the computing device 1200. The chipset 1206 may further provide an interface to a computer-readable storage medium, such as a read-only memory (ROM) 1220 or non-volatile RAM (NVRAM) (not shown), for storing basic routines that may help to start up the computing device 1200 and to transfer information between the various components and devices. ROM 1220 or NVRAM may also store other software components necessary for the operation of the computing device 1200 in accordance with the aspects described herein.

The computing device 1200 may operate in a networked environment using logical connections to remote computing nodes and computer systems through local area network (LAN) 1216. The chipset 1206 may include functionality for providing network connectivity through a network interface controller (NIC) 1222, such as a gigabit Ethernet adapter. A NIC 1222 may be capable of connecting the computing device 1200 to other computing nodes over a network 1216. It should be appreciated that multiple NICs 1222 may be present in the computing device 1200, connecting the computing device to other types of networks and remote computer systems.

The computing device 1200 may be connected to a mass storage device 1228 that provides non-volatile storage for the computer. The mass storage device 1228 may store system programs, application programs, other program modules, and data, which have been described in greater detail herein. The mass storage device 1228 may be connected to the computing device 1200 through a storage controller 1224 connected to the chipset 1206. The mass storage device 1228 may consist of one or more physical storage units. A storage controller 1224 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1200 may store data on a mass storage device 1228 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1228 is characterized as primary or secondary storage and the like.

For example, the computing device 1200 may store information to the mass storage device 1228 by issuing instructions through a storage controller 1224 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1200 may further read information from the mass storage device 1228 by detecting the physical states or characteristics of one or more particular locations within the physical storage units.

In addition to the mass storage device 1228 described above, the computing device 1200 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1200.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1228 depicted in FIG. 12, may store an operating system utilized to control the operation of the computing device 1200. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1228 may store other system or application programs and data utilized by the computing device 1200.

The mass storage device 1228 or other computer-readable storage media may also be encoded with computer-executable instructions, which, when loaded into the computing device 1200, transforms the computing device from a general-purpose computing system into a special-purpose computer capable of implementing the aspects described herein. These computer-executable instructions transform the computing device 1200 by specifying how the CPU(s) 1204 transition between states, as described above. The computing device 1200 may have access to computer-readable storage media storing computer-executable instructions, which, when executed by the computing device 1200, may perform the methods described in relation to FIGS. 6-11.

A computing device, such as the computing device 1200 depicted in FIG. 12, may also include an input/output controller 1232 for receiving and processing input from a number of input devices, such as a keyboard, a mouse, a touchpad, a touch screen, an electronic stylus, or other type of input device. Similarly, an input/output controller 1232 may provide output to a display, such as a computer monitor, a flat-panel display, a digital projector, a printer, a plotter, or other type of output device. It will be appreciated that the computing device 1200 may not include all of the components shown in FIG. 12, may include other components that are not explicitly shown in FIG. 12, or may utilize an architecture completely different than that shown in FIG. 12.

As described herein, a computing device may be a physical computing device, such as the computing device 1200 of FIG. 12. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, or in addition, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method comprising:
establishing, by a network assistance device, a connection with a gateway device, wherein a user device is connected to a first network via the gateway device, and wherein the user device is associated with a static Internet Protocol (IP) address on the first network;
based on a network condition associated with the first network, establishing, by the network assistance device, a connection with a second network;
receiving by the network assistance device, from a controller device, data indicative of the static IP address associated with the user device; and
establishing a connection between the user device and the network assistance device using the static IP address.

2. The method of claim 1, further comprising:
causing establishment of a tunnel between the network assistance device and the controller device, wherein receiving the data indicative of the static IP address comprises receiving the data indicative of the static IP address via the tunnel.

3. The method of claim 2, wherein causing establishment of the tunnel between the network assistance device and the controller device comprises sending, to the controller device, a message to initiate establishment of the tunnel.

4. The method of claim 2, wherein the tunnel comprises an Internet Protocol Security (IPsec) tunnel.

5. The method of claim 1, wherein the network assistance device and the gateway device are located at a same premises.

6. The method of claim 1, wherein the first network comprises a content provider network and the second network comprises at least one of a cellular network or a Long Term Evolution (LTE) network.

7. The method of claim 1, wherein the network condition associated with the first network comprises a state of a connection between the gateway device and the first network.

8. A method comprising:
establishing, by a user device, a connection to a first network via a gateway device, wherein the user device is associated with a static Internet Protocol (IP) address on the first network;
based on a network condition associated with the first network, establishing a connection with a network assistance device; and
causing establishment of a connection between the user device and a second network via the network assistance device using the static IP address.

9. The method of claim 8, wherein the network assistance device is configured to cause establishment of a tunnel between the network assistance device and a controller device and receive data indicative of the static IP address via the tunnel.

10. The method of claim 9, wherein the tunnel comprises an Internet Protocol Security (IPsec) tunnel.

11. The method of claim 8, wherein the network assistance device and the gateway device are located at a same premises.

12. The method of claim 8, wherein the first network comprises a content provider network and the second network comprises at least one of a cellular network or a Long Term Evolution (LTE) network.

13. The method of claim 8, wherein the network condition associated with the first network comprises a state of a connection between the gateway device and the first network.

14. A method comprising:
determining, by a controller device associated with a first network, a network condition associated with a first network, wherein a user device is associated with a static IP address on the first network;
establishing a connection between a network assistance device and a second network; and
sending, to the network assistance device, data indicative of the static IP address,
wherein the network assistance device is configured to cause establishment of a connection between the user device and the second network based on the static IP address.

15. The method of claim 14, further comprising:
causing establishment of a tunnel between the network assistance device and the controller device, wherein sending the data indicative of the static IP address comprises sending the data indicative of the static IP address via the tunnel.

16. The method of claim 15, wherein causing establishment of the tunnel between the network assistance device and the controller device associated with the first network is based on receiving, from the network assistance device, a message to initiate establishment of the tunnel.

17. The method of claim 15, wherein the tunnel comprises an Internet Protocol Security (IPsec) tunnel.

18. The method of claim 14, wherein the first network comprises a content provider network and the second network comprises at least one of a cellular network or a Long Term Evolution (LTE) network.

19. The method of claim 14, wherein the network condition associated with the first network comprises a state of a connection between a gateway device associated with the user device and the first network.

20. The method of claim 19, wherein the network assistance device and the gateway device are located at a same premises.
